(19) United States
(12) Patent Application Publication
(10) Pub. No.: US 2007/0252725 A1
(43) Pub. Date: Nov. 1, 2007

(54) Road-Condition Informing Apparatus and Road-Condition Informing Method

(75) Inventor: Shinsuke Nishida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FOURIE, Tokyo (JP)

(21) Appl. No.: 11/632,490

(22) PCT Filed: Jul. 16, 2004
(86) PCT No.: PCT/JP04/10569

§ 371 Date: Jan. 16, 2007

(51) Int. Cl. G08G 1/09

(52) U.S. Cl. 340/905

(57) ABSTRACT

A detecting unit that is provided at a detection position on a road detects a road condition near the detection position. A light emitting unit that is provided at the detection position emits a light. A control unit controls a light emission of the light emitting unit based on detected road condition.

### TECHNICAL FIELD

The present invention relates to a road-condition informing apparatus and a road-condition informing method, and more particularly, to a road-condition informing apparatus and a road-condition informing method with a capability of informing road conditions in real time at a low cost.

### BACKGROUND ART

Recently, there have been many traffic accidents on freeways and the like in which a vehicle crashes into another vehicle positioned at the end of traffic congestion, and various countermeasures have been taken. For instance, according to an example of methods for providing drivers of vehicles with information about traffic congestion, which is an example of road conditions, sensors for monitoring traffic congestion and information display boards are provided at a number of places on freeways. An integrated control apparatus judges whether there is traffic congestion based on detection results from the sensors, so that congestion information such as “Congestion Ahead” is displayed on the information display boards.

As a result, the drivers of the vehicles who see the congestion information on the information display boards pay attention and address the situation by, for example, reducing the speed of the vehicle, as necessary.

In addition, according to a conventional technique, a system that provides drivers of vehicles with information about traffic congestion has been put to practical use. In this system, an integrated control apparatus as described above transmits the information about traffic congestion to navigation apparatuses installed on the vehicles via optical/electric wave beacons disposed on the roads or via Frequency Modulation (FM) multiplex broadcasting (see Patent Document 1).

Patent Document 1: Japanese Patent Application Laid-open No. 2004-132737

According to the conventional technique, the integrated control apparatus exercises integrated control by collecting the detection results from the sensors and providing the information about the traffic congestion. Thus, it is necessary to maintain a network for connecting various units to the integrated control apparatus. Consequently, a problem arises where the cost is high.

Also, according to the conventional technique, after the detection results are collected in the integrated control apparatus first, a judgment is made on the condition of traffic congestion, before the information about the road conditions (i.e. the traffic congestion) is displayed on the information display boards. Thus, the processing performed by the integrated control apparatus takes time. Consequently, another problem arises where it is not possible to give information of the road conditions in a real-time manner.

In view of the problems explained above, it is an object of the present invention to provide a road-condition informing apparatus and a road-condition informing method with a capability of informing road conditions in real time at a low cost.

### DISCLOSURE OF INVENTION

To achieve the above object, a road-condition informing apparatus according to one aspect of the present invention includes a detecting unit configured to be provided at one of a plurality of detection positions on a road, and to detect a road condition near the detection position; a light emitting unit configured to be provided at the one of the detection positions, and to emit a light; and a control unit configured to control a light emission of the light emitting unit, based on a result of detection by the detecting unit, and to inform the road condition to a driver of a vehicle driving on the road.

A road-condition informing method according to another aspect of the present invention includes a detection step of detecting a road condition near one of a plurality of detection positions on a road; and a controlling step including controlling, based on a result of detection at the detection step, a light emission of a light emitting unit that is provided at the one of the detection positions and emits a light, and informing the road condition to a driver of a vehicle driving on the road.

According to the present invention, the light emitting state of the light emitting unit is controlled based on the result of the detection related to the road condition near one of the plurality of detection positions on the road, so that the driver of a vehicle driving on the road is informed of the road condition. Thus,-it is not necessary to use an integrated control apparatus as an intermediary, unlike in the system according to the conventional technique. Consequently, an effect is achieved where it is possible to give information of the road conditions at low cost and in a real-time manner.

### BRIEF DESCRIPTION OF DRAWINGS

FIG. 1 is a plan view for explaining installation of road-condition informing apparatuses 60₁ to 60₆ and road-condition informing apparatuses 70₁ to 70₆ according to an embodiment of the present invention;

FIG. 2 is a cross-sectional view at the line A-A shown in FIG. 1;

FIG. 3 is a block diagram of the road-condition informing apparatus 60₁ shown in FIG. 1 and a navigation apparatus 90 installed on a vehicle;

FIG. 4 is a schematic diagram of an example of a road condition display on a display unit 94 shown in FIG. 3;

FIG. 5 is a flowchart of an operation performed by each of the road-condition informing apparatuses 60₁ to 60₆ and the road-condition informing apparatuses 70₁ to 70₆ shown in FIG. 1; and

FIG. 6 is a cross-sectional view for explaining a modification example of the present embodiment.

### BEST MODE(S) FOR CARRYING OUT THE INVENTION

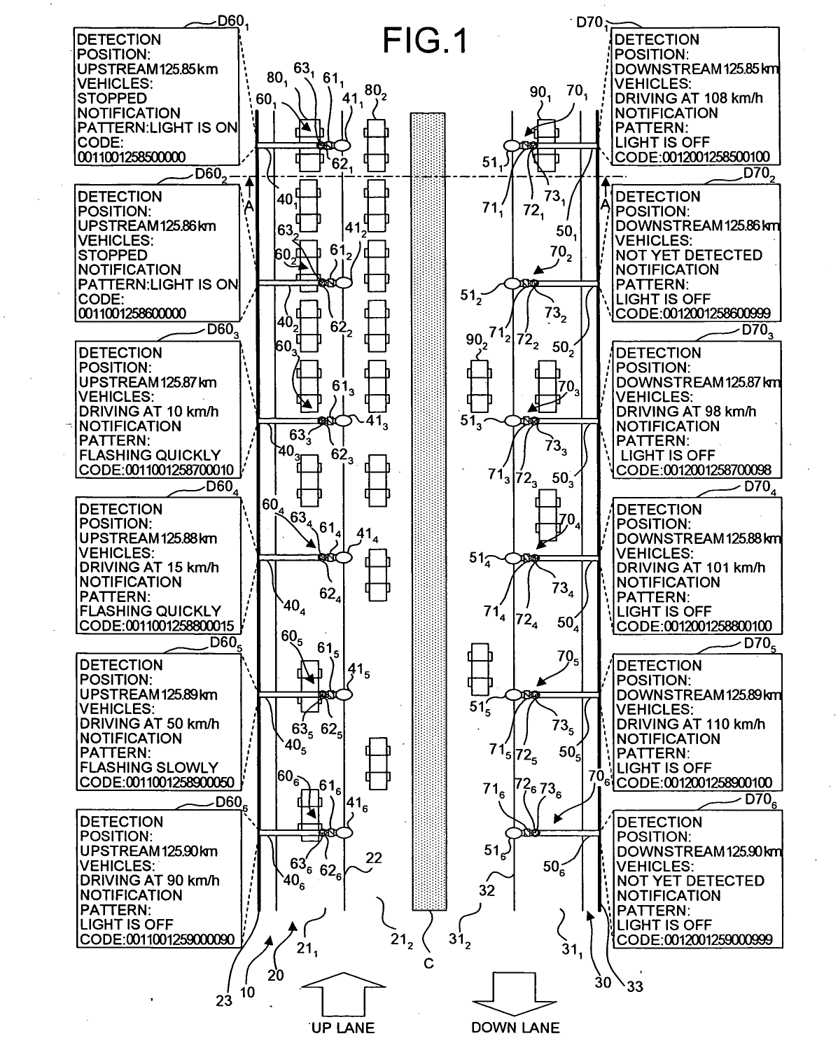

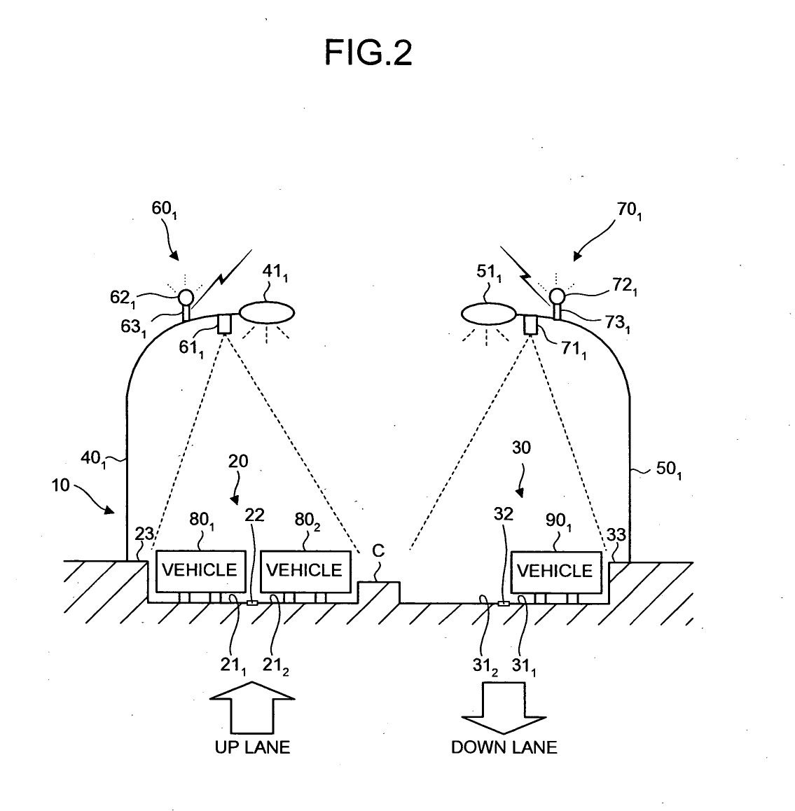

Exemplary embodiments of the present invention will be explained in detail below with reference to the accompanying drawings. FIG. 1 is a plan view for explaining installation of road-condition informing apparatuses according to an embodiment of the present invention. FIG. 2 is a cross-sectional view at the line A-A shown in FIG. 1. In these figures, a road-condition informing system for informing drivers of vehicles of road conditions (e.g. traffic congestion conditions) on a freeway 10 is shown.

As shown in FIG. 1, the freeway 10 has an up-lane road 20 and a down-lane road 30 on either side of a median strip C. The up-lane road 20 is made up of, for example, two lanes that are namely a first up lane 21₁ and a second up lane 21₂. On the up-lane road 20, a plurality of vehicles 80₁, 80₂, and so on are driving under a road condition as shown in the figure (i.e. in traffic congestion). More specifically, the up-lane road 20 is more congested as one drives along the up lane direction (i.e. the top of the drawing).

On a shoulder 23 of the up-lane road, a plurality of streetlight poles 40₁ to 40₆ are disposed with predetermined intervals therebetween (for example, 10 meters). The tip portion of each of the streetlight poles 40₁ to 40₆ is curved toward the median strip C side (see FIG. 2). In addition, streetlights 41₁ to 41₆ for illuminating the up-lane road 20 are attached to the tip portions of the streetlight poles 40₁ to 40₆, respectively.

On the other hand, like the up-lane road 20, the down-lane road 30 is also made up of two lanes that are namely a first down lane 31₁ and a second up lane 31₂. On the down-lane road 30, a plurality of vehicles 90₁, 90₂, and so on are driving under a road condition as shown in the figure (i.e. in no traffic congestion). More specifically, on the down-lane road 30, the vehicles 90₁, 90₂, and so on are driving smoothly.

On a shoulder 33 of the down-lane road, like on the shoulder 23 of the up-lane road, a plurality of streetlight poles 50₁ to 50₆ are disposed with predetermined intervals therebetween. The tip portion of each of the streetlight poles 50₁ to 50₆ is-curved toward the median strip C side (see FIG. 2). In addition, streetlights 51₁ to 51₆ for illuminating the down-lane road 30 are attached to the tip portions of the streetlight poles 50₁ to 50₆, respectively.

On the up-lane road 20 side, the road-condition informing apparatuses 60₁ to 60₆ are installed on the tip portions of the streetlight poles 40₁ to 40₆, respectively. After detecting the condition of the up-lane road 20 (for example, whether there is traffic congestion and the degree of the traffic congestion), each of the road-condition informing apparatuses 60₁ to 60₆ informs drivers of vehicles of the condition via light or wireless communication.

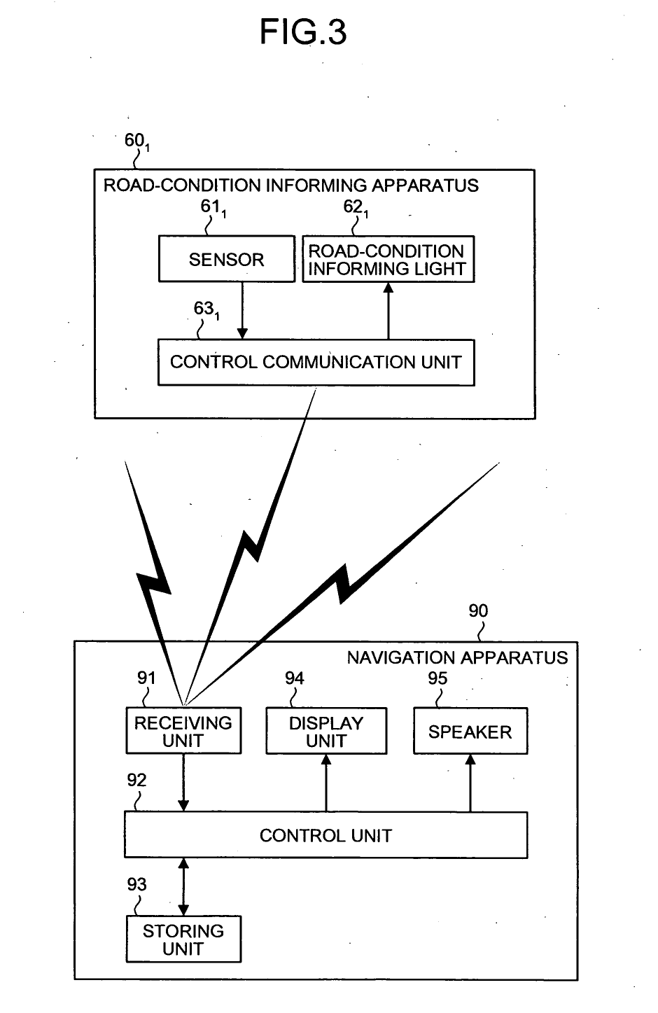

As shown in FIG. 2 and FIG. 3, the road-condition informing apparatus 60₁ includes a sensor 61₁, a road-condition informing light 62₁, and a control communication unit 63₁. As shown in FIG. 2, the sensor 61₁ is one of an ultrasound sensor, an infrared ray sensor, a wireless beacon, a metal sensor, a camera, and the like that is attached to the tip portion of the streetlight pole 40₁ and is a sensor that detects the road condition (e.g. whether there is any vehicle and the speed of the vehicle) on the up-lane road 20 that is positioned immediately underneath. The detection area of the sensor 61₁ is a predetermined area (of the up-lane road 20) positioned immediately underneath.

The road-condition informing light 62₁ is a colored lamp (for example, an orange lamp) that is attached to the tip portion of the streetlight pole 40₁ and has a function of informing the drivers of the vehicles of the road condition (whether there is traffic congestion-and the degree of the traffic congestion) via light (turning on the light, turning off the light, flashing the light, etc.).

Based on-the detection result from the sensor 61₁, the control communication unit 63₁ controls and drives the road-condition informing light 62₁ according to the road condition. The control communication unit 63₁ also transmits road-condition information D60₁, as shown in FIG. 1, to each of the navigation apparatuses (e.g. the navigation apparatus 90 shown in FIG. 3) installed on the vehicles, at intervals having a predetermined length.

The road-condition information D60₁includes information regarding “detection position”, “vehicles”, “information pattern”, and “code”. The road-condition information D60₁ is information that corresponds to the road condition detected by the sensor 61₁. The “detection position” is information that corresponds to the position at which the road condition has been detected. More specifically, the “detection position” corresponds to a distance marker called a “kilometer post” (expressing a distance [km] from a-reference point) at which the streetlight pole 40₁ is positioned on the freeway 10 and is expressed by a combination of one of “up lane” and “down lane” (“up lane” in the example in the figure) and the distance, that is, 125.85 kilometers.

The “vehicles” is information expressing whether there is any vehicle and the speed of the vehicle. The “information pattern” is a lighting pattern used by the. road-condition informing light 62₁ in correspondence with the detection result of the road condition. There are four lighting patterns such as the light is on, flashing slowly, flashing quickly, and off.

The information pattern with the light on means that a detection result of the road condition shows that the vehicles are stopped (the driving-speed=0 km/h) and-informs that there is a high degree of traffic congestion. The information pattern with the light flashing quickly corresponds to a detection result of the road condition having a driving speed lower than 20 km/h (except for stopped) and informs that there is a medium degree of traffic congestion. When the light is flashing quickly, it means that the light is flashing with shorter intervals than when the light is flashing slowly.

The information pattern with the light flashing slowly corresponds to a detection result of the road condition having a driving speed equal to or higher than 20 km/h and lower than 80 km/h and informs that there is a low degree of traffic congestion. The information pattern with the light off corresponds to a detection result of the road condition having a driving speed equal to or higher than 80 km/h and informs that there is no traffic congestion.

The “code” is a 16-digit number that expresses a road condition and can be divided into sections of 3 digits, 2 digits, 8 digits, and 3 digits from the left. The first three digits (“001” in the example in the figure) stand for a number (for example, Route 1) used for identifying the freeway.

The next two digits (“10” in the example in the figure) stand for one of “up lane” and “down lane” (“up lane”: 10; “down lane”: 20). The next eight digits (“01258500” in the example in the figure) correspond to the detection position of the road condition and stands for the kilometer post (125.85 km). The last three digits stand for the driving speed of vehicles (“000” in the example in the figure because the vehicles are stopped [=0 km/h]). When no vehicles have been detected yet the last three digits will be “999”.

Each of the other road-condition informing apparatuses 60₂ to 60₆ has the same configuration as the road-condition informing apparatus 60₁ and includes a corresponding one of sensors 61₂ to 61₆, a corresponding one of the road-condition informing lights 62₂ to 62₆, and a corresponding one of control communication units 63₂ to 63₆.

Each of the sensors 61₂ to 61₆ has the same configuration as the sensor 61₁ and is a sensor that detects a road condition (i.e. whether there is any vehicle and the speed of the vehicle) on the up-lane road 20 (i.e. in a detection area) positioned immediately underneath.

Each of the road-condition informing lights 62₂ to 62₆ has the same configuration as the road-condition informing light 62₁ and is a colored lamp (for example, an orange lamp) that is attached to a corresponding one of the tip portions of the streetlight poles 40₂ to 40₆. Each of the road-condition informing lights 62₂ to 62₆ also has the function of informing the drivers of the vehicles of the road condition (whether there is traffic congestion and the degree of the traffic congestion) via light (turning on the light, turning off the light, flashing the light, etc.).

Each of the control communication units 63₂ to 63₆ has the same configuration as the control communication unit 63₁ and controls and drives a corresponding one of the road-condition informing lights 62₂ to 62₆ according to the road condition, based on a detection result from a corresponding one of the sensors 61₂ to 61₆. Each of the control communication units 63₂ to 63₆ also transmits a corresponding one of the pieces of road-condition information D60₂ to D60₆ to each of the navigation apparatuses (e.g. the navigation apparatus 90 shown in FIG. 3) installed on the vehicles, at intervals having a predetermined length.

Like the road-condition information D60₁, each of the pieces of road-condition information D60₂ to D60₆ includes information regarding “detection position”, “vehicles”, “information pattern”, and “code”.

On the other hand, on the down-lane road 30 side, the road-condition informing apparatuses 70₁ to 70₆ are installed on the tip portions of the streetlight poles 50₁ to 50₆, respectively. After detecting the condition of the down-lane road 30 (for example, whether there is traffic congestion and the degree of the traffic congestion), each of the road-condition informing apparatuses 70₁ to 70₆ informs the drivers of the vehicles of the condition via light or wireless communication.

Each of the road-condition informing apparatuses 70₁ to 70₆ has the same configuration as the road-condition informing apparatus 60₁ and includes a corresponding one of sensors 71₁ to 71₆, a corresponding one of road-condition informing lights 72₁ to 72₆, and a corresponding one of control communication units 73₁ to 73₆.

Each of the sensors 71₁ to 71₆ has the same configuration as the sensor 61₁ and is a sensor that detects a road condition (i.e. whether there is any vehicle and the speed of the vehicle) on the down-lane road 30 (i.e. in a detection area) positioned immediately underneath.

Each of the road-condition informing lights 72₁ to 72₆ has the same configuration as the road-condition informing light 62₁ and is a colored lamp (for example, an orange lamp) that is attached to a corresponding one of the tip portions of the streetlight poles 50₁ to 50₆. Each of the road-condition informing lights 72₁ to 72₆ also has the function of informing the drivers of the vehicles of the road condition (whether there is traffic congestion and the degree of the traffic congestion) via light (turning on the light, turning off the light, flashing the light, etc.).

Each of the control communication units 73₁ to 73₆ has the same configuration as the control communication unit 63₁ and controls and drives a corresponding one of the road-condition informing lights 72₁ to 72₆ according to the road condition, based on a detection result from a corresponding one of the sensors 71₁ to 71₆. Each of the control communication units 73₁ to 73₆ also transmits a corresponding one of the pieces of road-condition information D70₁ to D70₆ to each of the navigation apparatuses (e.g. the navigation apparatus 90 shown in FIG. 3) installed on the vehicles, at intervals having a predetermined length.

Like the road-condition information D60₁, each of the pieces of road-condition information D70₁ to D70₆ includes information regarding “detection position”, “vehicles”, “information pattern”, and “code”.

The navigation apparatus 90 shown in FIG. 3 includes a receiving unit 91, a control unit 92, a storing-unit 93, a display unit 94, and a speaker 95. The navigation apparatus 90 is installed on each of the vehicles (i.e. the vehicles 80₁, 80₂, and so on and the vehicles 90₁, 90₂, and so on) driving on the freeway 10.

The navigation apparatus 90 is an apparatus that displays the position of the vehicle in a real-time manner on a map displayed on the display unit 94, based on a positioning result obtained by a well-known Global Positioning System (GPS), and guides the vehicle to a destination.

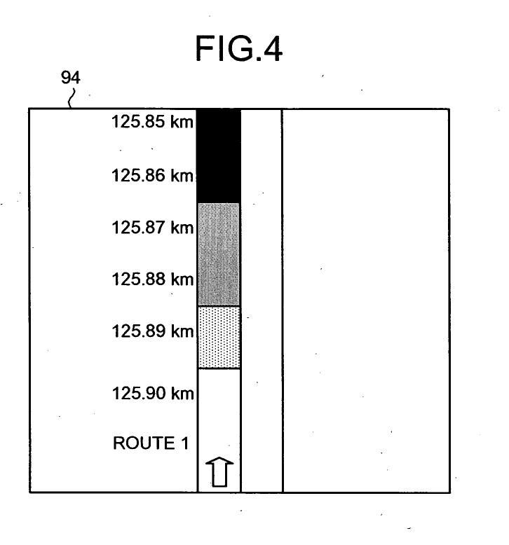

The navigation apparatus 90 also has a function of receiving the pieces of road-condition information D60₁ to D60₆ and the pieces of road-condition information D70₁ to D70₆ from the road-condition informing apparatuses 60₁ to 60₆ and the road-condition informing apparatuses 70₁ to 70₆, respectively and displaying the road conditions (i.e. traffic congestion conditions) on the display unit 94, as shown in FIG. 4.

The receiving unit 91 has a function of receiving a signal for the GPS, the pieces of road-condition information D60₁ to D60₆ and the pieces of road-condition information D70₁ to D70₆. The control unit 92 exercises various types of control related to guiding the vehicle and control for displaying the road conditions. The storing unit 93 stores therein information including road map information. The display unit 94 is provided near the driver of the vehicle and has a function of displaying the road conditions, in addition to guidance information such as a road map and a destination. The speaker 95 has a function of providing audio announcements about driving instructions, traffic congestion conditions, and the like.

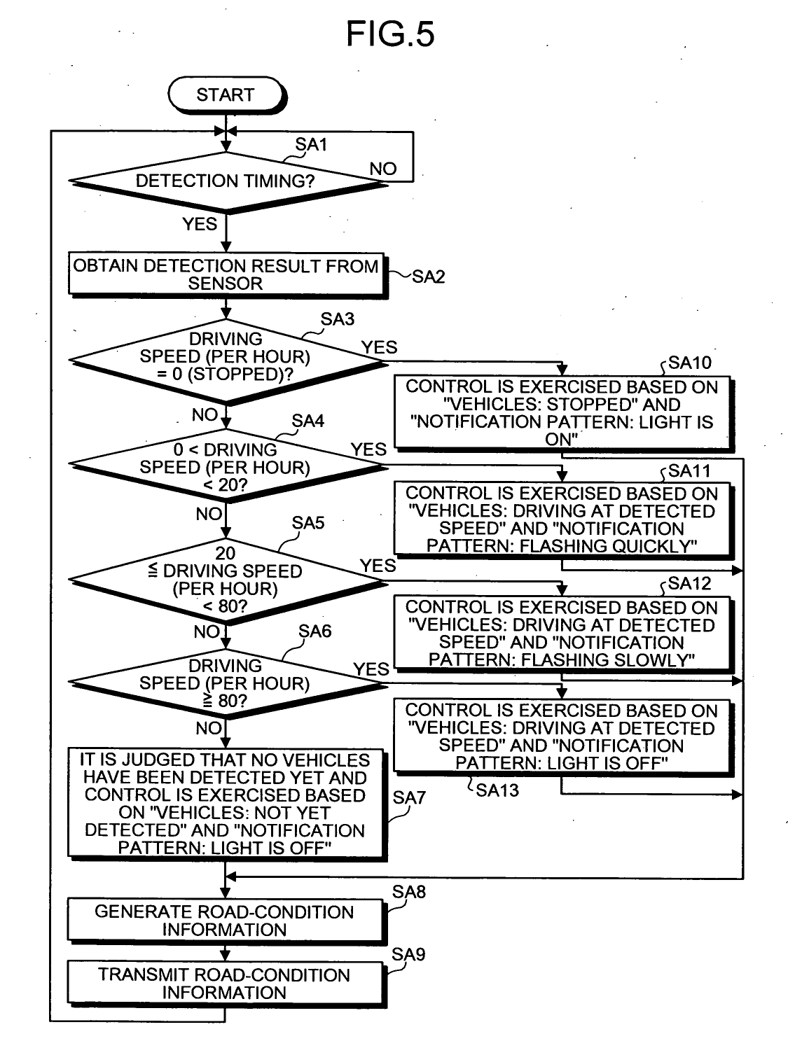

Next, the operation according to the exemplary embodiment-will be explained, with reference to a flowchart shown in FIG. 5. Under the road conditions (e.g. the degree of traffic congestion) of the up-lane road 20 as shown in FIG. 1, the control communication unit 63₁ included in the road-condition informing apparatus 60₁ (see FIG. 3) judges whether now is the time for detection that has been specified in advance (at intervals of a predetermined length). In the present example, the control communication unit 63₁ obtains a judging result of “No”, and repeatedly makes judgments.

When the time of detection has come, the control communication unit 63₁ obtains a judgment result of “Yes” at step SA1. At step SA2, the control communication unit 63₁ obtains a detection result of the condition of the road positioned immediately underneath, from the sensor 61₁. In the present example, the detection result from the sensor 61₁ shows that the driving speed of the vehicle 80₁ and the vehicle 802 is 0 km/h (i.e. the vehicles are stopped) because of a high degree of traffic congestion.

At step SA3, the control communication unit 63₁ judges whether the driving speed (per hour) is “0”, based on the detection result from the sensor 61₁. In the present example, the control communication unit 63₁ obtains a judgment result of “Yes”. At step SA10, the control communication unit 63₁ judges that there is a high degree of traffic congestion and exercises control so that the road-condition informing light 62₁ is on, based on “vehicles: stopped” and “information pattern: the light is on”. As a result, the road-condition informing light 62₁ is on. At step SA8, the control communication unit 63₁ generates road-condition information D60₁, based on the detection result from the sensor 61₁. After transmitting the road-condition information D60₁ at step SA9, the control communication unit 63₁ makes a judgment at step SA1.

Also, the control communication unit 63₂ included in the road-condition informing apparatus 60₂ judges, at step SA1, whether now is the time for detection that has been specified in advance (at intervals of a predetermined length). In the present example, the control communication unit 63₂ obtains a judging result of “No”, and repeatedly makes judgments.

When the time of detection has come, the control communication unit 63₂ obtains a judgment result of “Yes” at step SA1. At step SA2, the control communication unit 63₂ obtains a detection result of the condition of the road positioned immediately underneath, from the sensor 61₂. In the present example, the detection result from the sensor 61₂ shows that the driving speed of the vehicles positioned immediately underneath is 0 km/h (i.e. the vehicles are stopped) because of a high degree of traffic congestion.

At step SA3, the control communication unit 63₂ judges whether the driving speed (per hour) is “0”, based on the detection result from the sensor 612. In the present example, the control communication unit 632 obtains a judgment result of “Yes”. At step SA10, the control communication unit 632 judges that there is a high degree of traffic congestion and exercises control so that the road-condition informing light 622 is on, based on “vehicles: stopped” and “information pattern: the light is on”. As a result, the road-condition informing light 622 is on. At step SA8, the control communication unit 632 generates road-condition information D602, based on the detection result from the sensor 612. After transmitting the road-condition information D602 at step SA9, the control communication unit 632 makes a judgment at step SA1.

Also, the control communication unit 63₃ included in the road-condition informing apparatus 60₃ judges, at step SA1, whether now is the time for detection that has been specified in advance (at intervals of a predetermined length). In the present example, the control communication unit 63₃ obtains a judging result of “No”, and repeatedly makes judgments.

When the time of detection has come, the control communication unit 63₃ obtains a judgment result of “Yes” at step SA1. At step SA2, the control communication unit 63₃ obtains a detection result of the condition of the road positioned immediately underneath, from the sensor 61₃. In the present example, the detection result from the sensor 61₃ shows that the driving speed of the vehicles positioned immediately underneath is 10 km/h because of a medium degree of traffic congestion.

At step SA3, the control communication unit 63₃ judges whether the driving speed (per hour) is “0”, based on the detection result from the sensor 613. In the present example, the control communication unit 633 obtains a judgment result of “No”. At step SA4, the control communication unit 633 judges whether the driving speed (per hour) is higher than “0” and lower than “20”, based on the detection result from the sensor 61₃. In the present example, the control communication unit 63₃ obtains a judgment result of “Yes”.

At step SA11, the control communication unit 63₃ judges that there is a medium degree of traffic congestion and exercises control so that the road-condition informing light 62₃ flashes quickly, based on “vehicles: driving at 10 km/h” and “information pattern: flashing quickly”. As a result, the road-condition informing light 62₃ flashes quickly. At step SA8, the control communication unit 633 generates road-condition information D603, based on the detection result from the sensor 613. After transmitting the road-condition information D603 at step SA9, the control communication unit 633 makes a judgment at step SA1.

Also, the control communication unit 63₄ included in the road-condition informing apparatus 60₄ judges, at step SA1, whether now is the time for detection that has been specified in advance (at intervals of a predetermined length). In the present example, the control communication unit 63₄ obtains a judging result of “No”, and repeatedly makes judgments.

When the time of detection has come, the control communication unit 63₄ obtains a judgment result of “Yes” at step SA1. At step SA2, the control communication unit 63₄ obtains a detection result of the condition of the road positioned immediately underneath, from the sensor 61₄. In the present example, the detection result from the sensor 61₄ shows that the driving speed of the vehicles positioned immediately underneath is 15 km/h because of a medium degree of traffic congestion.

At step SA3, the control communication unit 63₄ judges whether the driving speed (per hour) is “0”, based on the detection result from the sensor 614. In the present example, the control communication unit 634 obtains a judgment result of “No”. At step SA4, the control communication unit 634 judges whether the driving speed (per hour) is higher than “0” and lower than “20”, based on the detection result from the sensor 61₄. In the present example, the control communication unit 63₄ obtains a judgment result of “Yes”.

At step SA11, the control communication unit 63₄ judges that there is a medium degree of traffic congestion and exercises control so that the road-condition informing light 62₄ flashes quickly, based on “vehicles: driving at 15 km/h” and “information pattern: flashing quickly”. As a result, the road-condition informing light 62₄ flashes quickly. At step SA8, the control communication unit 634 generates road-condition information D604, based on the detection result from the sensor 614. After transmitting the road-condition information D604 at step SA9, the control communication unit 634 makes a judgment at step SA1.

Also, the control communication unit 63₅ included in the road-condition informing apparatus 60₅ judges, at step SA1, whether now is the time for detection that has been specified in advance (at intervals of a predetermined length). In the present example, the control communication unit 63₅ obtains a judging result of “No”, and repeatedly makes judgments.

When the time of detection has come, the control communication unit 63₅ obtains a judgment result of “Yes” at step SA1. At step SA2, the control communication unit 63₅ obtains a detection result of the condition of the road positioned immediately underneath, from the sensor 61₅. In the present example, the detection result from the sensor 61₅ shows that the driving speed of the vehicles positioned immediately underneath is 50 km/h because of a low degree of traffic congestion.

At step SA3, the control communication unit 63₅ judges whether the driving speed (per hour) is “0”, based on the detection result from the sensor 615. In the present example, the control communication unit 635 obtains a judgment result of “No”. At step SA4, the control communication unit 635 judges whether the driving speed (per hour) is higher than “0” and lower than “20”, based on the detection result from the sensor 61₅. In the present example, the control communication unit 63₅ obtains a judgment result of “No”.

At step SA5, the control communication unit 63₅ judges whether the driving speed (per hour) is equal to or higher than “20” and lower than “80”, based on the detection result from the sensor 61₅. In the present example, the control communication unit 63₅ obtains a judgment result of “Yes”.

At step SA12, the control communication unit 63₅ judges that there is a low degree of traffic congestion and exercises control so that the road-condition informing light 62₅ flashes slowly, based on “vehicles: driving at 50 km/h” and “information pattern: flashing slowly”. As a result, the road-condition informing light 62₅ flashes slowly. At step SA8, the control communication unit 635 generates road-condition information D605, based on the detection result from the sensor 615. After transmitting the road-condition information D605 at step SA9, the control communication unit 635 makes a judgment at step SA1.

Also, the control communication unit 63₆ included in the road-condition informing apparatus 60₆ judges, at step SA1, whether now is the time for detection that has been specified in advance (at intervals of a predetermined length). In the present example, the control communication unit 63₆ obtains a judging result of “No”, and repeatedly makes judgments.

When the time of detection has come, the control communication unit 63₆ obtains a judgment result of “Yes” at step SA1. At step SA2, the control communication unit 63₆ obtains a detection result of the condition of the road positioned immediately underneath, from the sensor 61₆. In the present example, the detection result from the sensor 61₆ shows that the driving speed of the vehicles positioned immediately underneath is 90 km/h because there is no traffic congestion.

At step SA3, the control communication unit 63₆ judges whether the driving speed (per hour) is “0”, based on the detection result from the sensor 616. In the present example, the control communication unit 636 obtains a judgment result of “No”. At step SA4, the control communication unit 636 judges whether the driving speed (per hour) is higher than “0” and lower than “20”, based on the detection result from the sensor 61₆. In the present example, the control communication unit 63₆ obtains a judgment result of “No”.

At step SA5, the control communication unit 63₆ judges whether the driving speed (per hour) is equal to or higher than “20” and lower than “80”, based on the detection result from the sensor 61₆. In the present example, the control communication unit 63₆ obtains a judgment result of “No”.

At step SA6, the control communication unit 63₆ judges whether the driving speed (per hour) is equal to or higher than “80”, based on the detection result from the sensor 61₆. In the present example, the control communication unit 63₆ obtains a judgment result of “Yes”.

At step SA13, the control communication unit 63₆ judges that there is no traffic congestion and exercises control so that the road-condition informing light 62₆ is off, based on “vehicles: driving at 90 km/h” and “information pattern: the light is off”. As a result, the road-condition informing light 62₆ is off. At step SA8, the control communication unit 636 generates road-condition information D606, based on the detection result from the sensor 616. After transmitting the road-condition information D606 at step SA9, the control communication unit 636 makes a judgment at step SA1.

On the other hand, under the road conditions (e.g. the degree of traffic congestion) of the down-lane road 30, the control communication unit 73₁ included in the road-condition informing apparatus 70₁ judges, at step SA1, whether now is the time for detection that has been specified in advance (at intervals of a predetermined length). In the present example, the control communication unit 73₁ obtains a judging result of “No”, and repeatedly makes judgments.

When the time of detection has come, the control communication unit 73₁ obtains a judgment result of “Yes” at step SA1. At step SA2, the control communication unit 73₁ obtains a detection result of the condition of the road positioned immediately underneath, from the sensor 71₁. In the present example, the detection result from the sensor 71₁ shows that the driving speed of the vehicles positioned immediately underneath is 108 km/h because there is no traffic congestion.

At step SA3, the control communication unit 73₁ judges whether the driving speed (per hour) is “0”, based on the detection result from the sensor 71₁. In the present example, the control communication unit 73₁ obtains a judgment result of “No”. At step SA4, the control communication unit 73₁ judges whether the driving speed (per hour) is higher than “0” and lower than “20”, based on the detection result from the sensor 71₁. In the present example, the control communication unit 73₁ obtains a judgment result of “No”.

At step SA5, the control communication unit 73₁ judges whether the driving speed (per hour) is equal to or higher than “20” and lower than “80”, based on the detection result from the sensor 71₁. In the present example, the control communication unit 73₁ obtains a judgment result of “No”.

At step SA6, the control communication unit 73₁ judges whether the driving speed (per hour) is equal to or higher than “80”,based on the detection result from the sensor 71₁. In the present example, the control communication unit 73₁ obtains a judgment result of “Yes”.

At step SA13, the control communication unit 73₁ judges that there is no traffic congestion and exercises control so that the road-condition informing light 72₁ is off, based on “vehicles: driving at 108 km/h” and “information pattern: the light is off”. As a result, the road-condition informing light 72₁ is off. At step SA8, the control communication unit 73₁ generates road-condition information D70₁, based on the detection result from the sensor 71₁. After transmitting the road-condition information D70₁ at step SA9, the control communication unit 73₁ makes a judgment at step SA1.

Also, the control communication unit 73₂ included in the road-condition informing apparatus 70₂ judges, at step SA1, whether now is the time for detection that has been specified in advance (at intervals of a predetermined length). In the present example, the control communication unit 73₂ obtains a judging result of “No”, and repeatedly makes judgments.

When the time of detection has come, the control communication unit 73₂ obtains a judgment result of “Yes” at step SA1. At step SA2, the control communication unit 73₂ obtains a detection result of the condition of the road positioned immediately underneath, from the sensor 71₂. In the present example, the detection result from the sensor 71₂ shows that no vehicles have been detected yet because there are no vehicles positioned directly underneath.

At step SA3, the control communication unit 73₂ judges whether the driving speed (per hour) is “0”, based on the detection result from the sensor 712. In the present example, the control communication unit 732 obtains a judgment result of “No”. At step SA4, the control communication unit 732 judges whether the driving speed (per hour) is higher than “0” and lower than “20”, based on the detection result from the sensor 712. In the present example, the control communication unit 732 obtains a judgment result of “No”.

At step SA5, the control communication unit 73₂ judges whether the driving speed (per hour) is equal to or higher than “20” and lower than “80”, based on the detection result from the sensor 712. In the present example, the control communication unit 732 obtains a judgment result of “No”.

At step SA6, the control communication unit 73₂ judges whether the driving speed (per hour) is equal to or higher than “80”, based on the detection result from the sensor 712. In the present example, the control communication unit 732 obtains a judgment result of “No”.

At step SA7, the control communication unit 73₂ judges that no vehicles have been detected yet (which has the same meaning as no traffic congestion) and exercises control so that the road-condition informing light 722 is off, based on “vehicles: not yet detected” and “information pattern: the light is off”. As a result, the road-condition informing light 722 is off. At step SA8, the control communication unit 732 generates road-condition information D702, based on the detection result from the sensor 712. After transmitting the road-condition information D702 at step SA9, the control communication unit 732 makes a judgment at step SA1.

In the same manner as described above, also in the road-condition informing apparatuses 70₃ to 70₆, the road condition is detected by each of the sensors 71₃ to 71₆, each of the road-condition informing lights 72₃ to 72₆ is controlled, and each of the pieces of road-condition information D70₃ to D70₆ is generated and transmitted.

As a result of the control exercised as described above, on the up-lane road 20, road-condition informing lights 62₁, 62₂, 62₃, 62₄, 62₅, and 62₆ are, respectively, on, flashing quickly, flashing quickly, flashing slowly, and off, according to the road conditions (i.e. the degrees of the congestion). With these arrangements, the drivers of the vehicles on the freeway 10 are able to visually recognize the road conditions ahead in a real-time and appropriate manner.

On the other hand, on the down-lane road 30, because there is no traffic congestion, all of the road-condition informing lights 72₁ to 72₆ are off.

The pieces of road-condition information D60₁ to D60₆ and the pieces of road-condition information D70₁ to D70₆ are transmitted from the road-condition informing apparatuses 60₁ to 60₆ and the road-condition informing apparatuses 70₁ to 70₆, respectively, at each time of detection so that the pieces of road-condition information are not in synchronization with one another.

The pieces of road-condition information D60₁ to D60₆ and the pieces of road-condition information D70₁ to D70₆ are sequentially received by the receiving unit 91 included in the navigation apparatus 90, as shown in FIG. 3, that is installed on each of the vehicles that are positioned, for example, on the down lane side (at the bottom of FIG. 1) of the up-lane road 20.

The control unit 92 included in the navigation apparatus 90 analyzes the pieces of road-condition information D60₁ to D60₆ and the pieces of road-condition information D70₁ to D70₆ and causes the display unit 94 shown in FIG. 4 to display the road conditions being mapped on a road map. In FIG. 4, a road map that corresponds to the freeway 10 shown in FIG. 1 and the road conditions (the degrees of the traffic congestion are expressed by, for example, the darkness of the hatched areas) are displayed.

Accordingly, the drivers of the vehicles on each of which the navigation apparatus 90 is installed are able to recognize the road condition ahead in a real-time and appropriate manner, from the display unit 94.

According to another exemplary embodiment, an arrangement is acceptable in which the road conditions ahead are provided by way of an audio announcement from the speaker 95, saying, for example, “on the up-lane road, there is traffic congestion with the traffic stopped at the 125.85 km point”, “on the up-lane road, the traffic is moving at 10 km/h, at the 128.87 km point”, and “on the up-lane road, the traffic is moving at 90 km/h, at the 125.90 km point”.

According to another exemplary embodiment, an arrangement is acceptable, in which the road conditions are displayed on the front windshield glass or on a head-up display, instead of on the display unit 94 shown in FIG. 3.

Further, according to another exemplary embodiment, an arrangement is acceptable in which, when the road-condition informing light should be off (i.e. when no vehicles have been detected yet and when the driving speed is “0”), the road-condition information does not get transmitted.

As explained so far, according to the exemplary embodiment, the light emitting state (i.e. the light is on, flashing quickly, flashing slowly, or off) of the road-condition informing unit 62₁ and so on is controlled, based on the detection result regarding the road condition (for example, the traffic congestion condition) near one of the plurality of detection positions on the up-lane road 20 of the freeway 10 so that the drivers of the vehicles driving on the up-lane road 20 of the freeway 10 are informed of the road condition. Thus, it is not necessary to use an integrated control apparatus as an intermediary, unlike in the system according to the conventional technique. Consequently, it is possible to give information of the road conditions at low cost and in a real-time manner.

In the description above, the exemplary embodiment of the present invention has been explained with reference to the drawings. However, specific configuration examples of the present invention are not limited to the exemplary embodiment. Other various embodiments to each of which a design modification or the like has been applied without departing from-the gist of the present invention are also considered as a part of the present invention.

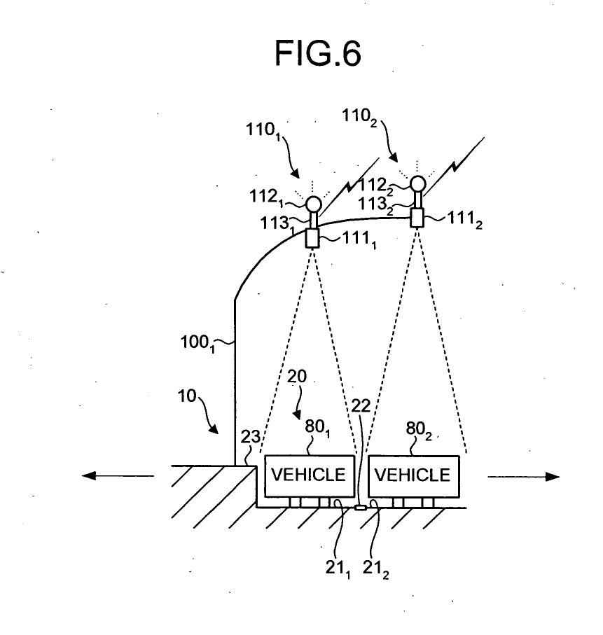

For example, according to another exemplary embodiment, an arrangement is acceptable in which a set of road-condition informing apparatuses are provided for each of the lanes (or for each of types of vehicles), as shown in FIG. 6, so that more detailed information of the road conditions can be given.

In FIG. 6, a pole 100₁ is disposed on the shoulder 23 of the up-lane road. On the tip portion of the pole 100₁, a first road-condition informing apparatus 110₁ and a second road-condition informing apparatus 110₂ are installed.

The first road-condition informing apparatus 110₁ is an apparatus that, after detecting the condition (for example, whether there is traffic congestion and the degree of the traffic congestion) of the first up lane 21₁ of the up-lane road 20, informs drivers of vehicles of the detected condition via light or wireless communication. Like the road-condition informing apparatus 60₁ (see FIG. 2), the first road-condition informing apparatus 110₁ includes a first sensor 111₁, a first road-condition informing light 112₁, and a first control communication unit 113₁.

The first sensor 111₁ is one of an ultrasound sensor, an infrared ray sensor, a wireless beacon, a metal sensor, a camera, and the like that is attached to the upper portion of the pole 100₁ and is a sensor that detects the road condition (i.e. whether there is any vehicle and the speed of the vehicle) in the first up lane 21₁ positioned immediately underneath.

The first road-condition informing light 112₁ is a colored lamp (for example, an orange lamp) that is attached to the upper portion of the pole 100₁ and has a function of informing the drivers of the vehicles of the road condition (whether there is traffic congestion and the degree of the traffic congestion) via light (turning on the light, turning off the light, flashing the light, etc.).

The first control communication unit 113₁ controls and drives, based on the detection result from the first sensor 111₁, the first road-condition informing light 112₁ according to the road condition. The first control communication unit 113₁ also transmits the road-condition information to each of the navigation apparatuses (not shown) installed on the vehicles, at intervals having a predetermined length.

On the other hand, the second road-condition informing apparatus 110₂ is an apparatus that, after detecting the condition (for example, whether there is traffic congestion and the degree of the traffic congestion) of the second up lane 21₂ of the up-lane road 20, informs the drivers of the vehicles of the detected condition via light or wireless communication. Like the first road-condition informing apparatus 110₁, the second road-condition informing apparatus 110₂ includes a second sensor 111₂, a second road-condition informing light 112₂, and a second control communication unit 113₂.

The second sensor 111₂ is one of an ultrasound sensor, an infrared ray sensor, a wireless beacon, a metal sensor, a camera, and the like that is attached to the tip portion of the pole 100₁ and is a sensor that detects the road condition (i.e. whether there is any vehicle and the speed of the vehicle) in the second up lane 21₂ positioned immediately underneath.

The second road-condition informing light 112₂ is a colored lamp (for example, an orange lamp) that is attached to the tip portion of the pole 100₁ and has a function of informing the drivers of the vehicles of the road condition (whether there is traffic congestion and the degree of the traffic congestion) via light (turning on the light, turning off the light, flashing the light, etc.).

The second control communication unit 113₂ controls and drives, based on the detection result from the second sensor 111₂, the second road-condition informing light 112₂ according to the road condition. The second control communication unit 113₂ also transmits the road-condition information to each of the navigation apparatuses (not shown) installed on the vehicles, at intervals having a predetermined length.

In the description of the exemplary embodiment, the example in which the road-condition informing apparatuses are used on a freeway has been explained. However, it is acceptable to use the road-condition informing apparatuses in a tunnel or on-a bridge. In such a situation, the plurality of road-condition informing apparatuses may be installed on the ceiling of a tunnel or on the beam of a bridge, with predetermined intervals therebetween.

In the description of the exemplary embodiment, the example has been explained in which the drivers of the vehicles are informed of the road conditions by way of changing the lighting state (i.e. the light is on, flashing quickly, flashing slowly, or off) of the road-condition informing lights 62₁ to 62₆. However, another arrangement is acceptable in which each of the road-condition informing lights is able to emit light in multiple colors so that the drivers of the vehicles are informed of the road conditions by way of changing the color (or changing the combination of a color and a lighting state).

Further, in the description of the exemplary embodiment, the example has been explained in which the pieces of road-condition information D60₁ to D60₆ and the like that correspond to the road conditions are transmitted to the vehicles. However, another arrangement is acceptable, in which the pieces of road-condition information D60₁ to D60₆ and the like are transmitted to an integrated control apparatus via wired communication, wireless communication, or the like.

Furthermore, it is acceptable to arrange the exemplary embodiment so that when a result of an analysis of the received pieces of road-condition information D60₁ to D60₆ and the like performed by the control unit 92 included in the navigation apparatus (see FIG. 3) shows that there is congestion ahead at a close location, the vehicle is controlled and automatically braked so that the speed is reduced.

In addition, in the description of the exemplary embodiment, the-example has been explained in detail in which the information related to traffic congestion is used as an example of the road-condition information. However, the road-condition information may be any other types of information as long as the information is useful information that should be provided for drivers of vehicles to help them drive safely. For example, the road-condition information may include the following types of information (1) to (5):
(1) congestion condition information as described above;
(2) information regarding the conditions of the road surfaces (cave-ins, landslides, collapses of bridge supports, road surface freezing, and so on);
(3) information regarding weather conditions (rain, fog, thunderstorms, snow, windstorms, earthquakes, and so on);
(4) information regarding the conditions on the roads (traffic accidents, fires, people or animals on the roads, objects fell on the roads and so on); and
(5) driving conditions of vehicles (short distance between vehicles, zigzagging on the roads, driving in an opposite direction of the traffic flow, driving while making noise).

As a sensor for detecting the conditions (1) to (5) listed above, it is appropriate to use the following devices (a) to (g), respectively:
(a) meteorological sensors for (3);
(b) cameras (or images) for (1) to (5);
(c) ultrasound sensors and wireless beacons for (1);
(d) vibration sensors, acceleration sensors, and seismometers, for (2) and (3);
(e) fire sensors for (4);
(f) sound sensors (or microphones) for (4) (to detect the sound from passing emergency vehicles and accidents) and (5); and
(g) optical sensors (to scan the road surfaces with laser beams) for (1) to (5).

It is acceptable to modify the exemplary embodiment by using a light-emitting-type level gauge instead of the road-condition informing light 62, and the like, so that a level is displayed according to the congestion condition.

Also, it is acceptable to modify the exemplary embodiment by attaching a light to each of the streetlight poles and displaying, with the light, information according to the congestion conditions (for example, information being expressed by flashing the light or turning on the light) toward the surface of the roads (or preferably toward a white line 22 or a white line 32).

Further, in the description of the exemplary embodiment, the example has been described in which the road-condition informing apparatus 60₁ and so on are installed on the streetlight pole 40₁ and so on, respectively. However, another arrangement is acceptable in which the road-condition informing apparatus 60₁ and so on are installed on objects positioned on the roads such as guardrails or electric poles, instead of on the streetlight pole 40₁ and so on.

Further, it is acceptable to modify the exemplary embodiment by giving information of traffic congestion as if there was traffic congestion at a position before the actual location of the traffic congestion, so that there is enough time to address the situation by, for example, reducing the speed of the vehicle before the traffic congestion. With this arrangement, it is possible to achieve an effect where vehicles are prevented from crashing into other vehicles.

Furthermore, it is acceptable to realize the functions according to the exemplary embodiment by having a program recorded onto a computer-readable recording medium and having the program that has been recorded on the recording medium read and executed by a computer, the program being used for realizing the functions of the road-condition informing apparatuses and the navigation apparatus 90.

### INDUSTRIAL APPLICABILITY

As explained above, the road-condition informing apparatus and the road-condition informing method according to the present invention are useful in, for example, informing drivers of vehicles of congestion conditions on freeways.

1-8. (canceled)

9. An apparatus for informing a road condition of a road to a driver of a vehicle driving on the road, the apparatus comprising:
a detecting unit configured to be provided at a detection position on the road and to detect the road condition near the detection position;
a light emitting unit configured to be provided at the detection position and to emit a light; and
a control unit that controls a light emission of the light emitting unit based on detected road condition.

10. The apparatus according to claim 9, further comprising:
a transmitting unit that transmits information on the detected road condition to the vehicle driving on the road.

11. The apparatus according to claim 9, wherein
the light emitting unit emits the light toward a surface of the road.

12. The apparatus according to claim 9, wherein
the detecting unit is provided in correspondence with a single lane of a road having a plurality of lanes.

13. A system for informing a road condition of a road to a driver of a vehicle driving on the road, the system comprising:
a plurality of road-condition informing apparatuses provided at a plurality of detection positions on the road, wherein
each of the road-condition informing apparatuses includes
a detecting unit that detects the road condition near corresponding detection position;
a light emitting unit that emits a light; and
a control unit that controls a light emission of the light emitting unit based on detected road condition.

14. The system according to claim 13, wherein
the light emitting unit is positioned above the road, and
light emissions of light emitting units of the road-condition informing apparatuses and are recognized by the driver of the vehicle driving toward the light emitting units in an ascending order of respective distances from the vehicle.

15. The system according to claim 13 wherein
the light emitting unit emits the light toward a surface of the road.

16. The system according to claim 13, wherein
the detecting unit is provided in correspondence with a single lane of a road having a plurality of lanes.

17. The system according to claim 13, wherein
each of the road-condition informing apparatuses further includes
a transmitting unit that transmits information on the detected road condition to the vehicle driving on the road.

18. The system according to claim 17, wherein
the vehicle includes:
a receiving unit that receives the detected road condition from the transmitting unit of each of the road-condition informing apparatuses;
a control unit that analyzes a traffic condition of the road based on received road condition; and
a display unit that displays thereon analyzed traffic condition.

19. The system according to claim 17, wherein
the vehicle includes
a receiving unit that receives the detected road condition from the transmitting unit of each of the road-condition informing apparatuses; and
a control unit that analyzes a traffic condition of the road based on received road condition, and controls a speed of the vehicle based on analyzed traffic condition.

20. A method of informing a road condition of a road to a driver of a vehicle driving on the road, the method comprising:
detecting the road condition near a detection position on the road; and
controlling a light emission of a light emitting unit provided at the detection position based on detected road condition.
